(19) United States
(12) Patent Application Publication
(10) Pub. No.: US 2020/0198353 A1
(43) Pub. Date: Jun. 25, 2020

(54) EJECTION NOZZLE CLEANING DEVICE FOR INKJET PRINTER

(71) Applicant: MIMAKI ENGINEERING CO., LTD., Nagano (JP)

(72) Inventor: Tomomi Igawa, Nagano (JP)

(73) Assignee: MIMAKI ENGINEERING CO., LTD., Nagano (JP)

(21) Appl. No.: 15/751,466

(22) PCT Filed: Aug. 19, 2016
(86) PCT No.: PCT/JP2016/074279

§ 371 Date: Feb. 8, 2018

(30) Foreign Application Priority Data
Aug. 21, 2015 (JP) 2015-163486

(51) Int. Cl. B41J 2/165

(52) U.S. Cl. CPC B41J 2/16517

(57) ABSTRACT

An ejection nozzle cleaning device includes: a gripping portion held by a user; a horn protruding from one end of the gripping portion and extending away therefrom; a reservoir disposed on one side of the horn in an extending direction in which the horn is extending; and an ultrasonic generator disposed on another side of the horn in the extending direction. The reservoir is a tubular member with a closed bottom and an opening in a part thereof that faces the ink ejection face. The reservoir has a storage space where a cleaning liquid is containable. The reservoir has a through cavity allowing the horn to be at least partly inserted and located in the storage space. A peripheral wall surrounding the opening of the reservoir is formed to a height, which allows one side of a vibration transmitter of the horn to be located in the storage space.

### TECHNICAL FIELD

This invention relates to an ejection nozzle cleaning device for inkjet printers.

### BACKGROUND ART

The inkjet head of an inkjet printer has an ink ejection face on a side thereof that faces a print medium, and a plurality of ink ejection nozzles arranged on the ink ejection face.

The inkjet printer prints an object on a print medium by ejecting ink through the ejection nozzles onto the print medium.

The ejection nozzles may be clogged with dust and/or ink mist adhered to and solidified in the nozzles, or ink inside the ejection nozzles with an inferior cover may easily dry and solidify, clogging the nozzles. Then, the ejection of ink may no longer be possible with such clogged nozzles.

The failure to eject ink through the ejection nozzles during the printing may leave ink-missing parts on the print medium, degrading the quality of a printed matter.

A broad range of devices have so far been discussed and developed to remove the adhered ink from the nozzles. Some of such devices are aimed at improving a cleaning effect by having ultrasonic vibration transmitted and acted upon on the nozzles (for example, patent literature 1, 2).

### CITATION LIST

### Patent Literature

Patent Literature 1: Japanese Unexamined Patent Publication No.2006-347000

Patent Literature 2: Japanese Unexamined Patent Publication No.2014-69351

The patent literature 1 describes a method for removing solidified ink adhered to the nozzles. This method uses a cap in which a cleaning liquid is containable that is sized large enough to cover all of the nozzles on the ink ejection face. With the cap containing the cleaning liquid being pushed against the ink ejection face, ultrasonic vibration transmitted through the cap is acted upon the cleaning liquid to remove the solidified ink from the nozzles.

The patent literature 2 describes another method for removing solidified ink adhered to the ejection nozzles, in which ultrasonic vibration is acted upon a brush supplied with a cleaning liquid.

To attain a satisfactory cleaning effect, the action of ultrasonic vibration should desirably pinpoint clogged parts of the nozzles. In this regard, cleaning effects obtained by the methods of the patent literature 1 and the patent literature 2 may be insufficient, because ultrasonic vibration can only be acted upon the cleaning liquid through the cap or brush.

The method described in the patent literature 2 may have another issue, which is difficulty in spreading the cleaning liquid all over the nozzle surface. This may be another factor leading to a rather poor cleaning result.

To address these issues, effective means for improving the cleaning effects of the known art are desirably developed to solve the problem of clogged ejection nozzles.

### SUMMARY

### Solutions to the Problems

This invention provides an ejection nozzle cleaning device for an inkjet printer having a plurality of ink ejection nozzles that are arranged on an ink ejection face of an inkjet head. The ejection nozzle cleaning device includes: a gripping portion to be held by a user; a horn protruding from one end of the gripping portion and extending away from the gripping portion; a reservoir disposed on one side of the horn in an extending direction in which the horn is extending, the reservoir being equipped to contain a cleaning liquid; and an ultrasonic generator disposed on another side of the horn in the extending direction in which the horn is extending so as to transmit an ultrasonic wave to the horn. The reservoir is a tubular member with a closed bottom and an opening in a part thereof that faces the ink ejection face. The reservoir has an interior in which the cleaning liquid is containable and has a through cavity that allows the horn to be at least partly inserted and located in the interior. A wall that surrounds the opening of the reservoir is formed to a height that allows the one side of the horn to be located in the interior.

### Effect of the Invention

This invention may achieve a satisfactory cleaning effect by having the cleaning liquid of the reservoir directly vibrated by ultrasonic wave.

### BRIEF DESCRIPTION OF THE DRAWINGS

FIG. 1 is a drawing that illustrates an overall structure of an ejection nozzle cleaning device for an inkjet printer according to an embodiment of this invention.

FIG. 2 are detailed drawings of the ejection nozzle cleaning device.

FIG. 3 are enlarged views of a main structural unit in the ejection nozzle cleaning device.

FIG. 4 are drawings of a reservoir in the ejection nozzle cleaning device.

### DESCRIPTION OF EMBODIMENT

An embodiment of this invention is hereinafter described.

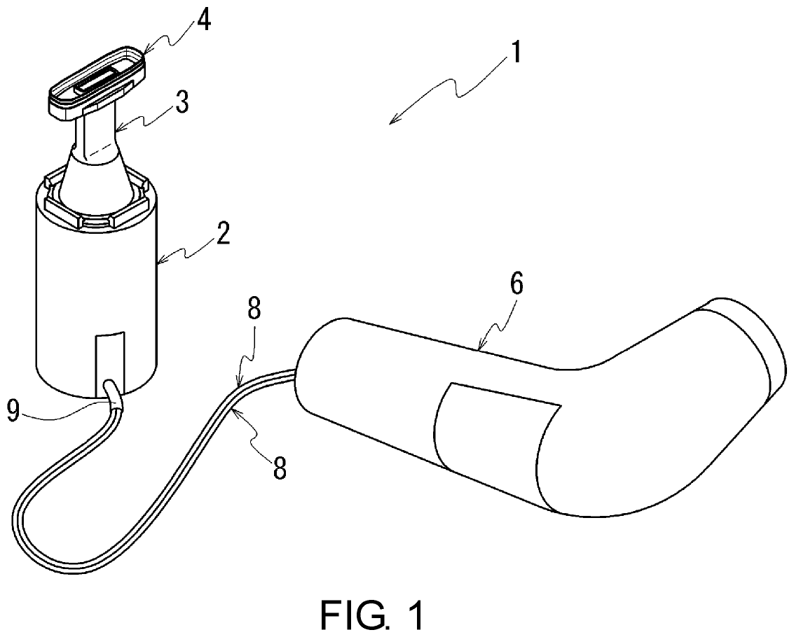

FIG. 1 is a drawing that illustrates an overall structure of an ejection nozzle cleaning device 1 for inkjet printers according to an embodiment of this invention (hereinafter, ejection nozzle cleaning device 1).

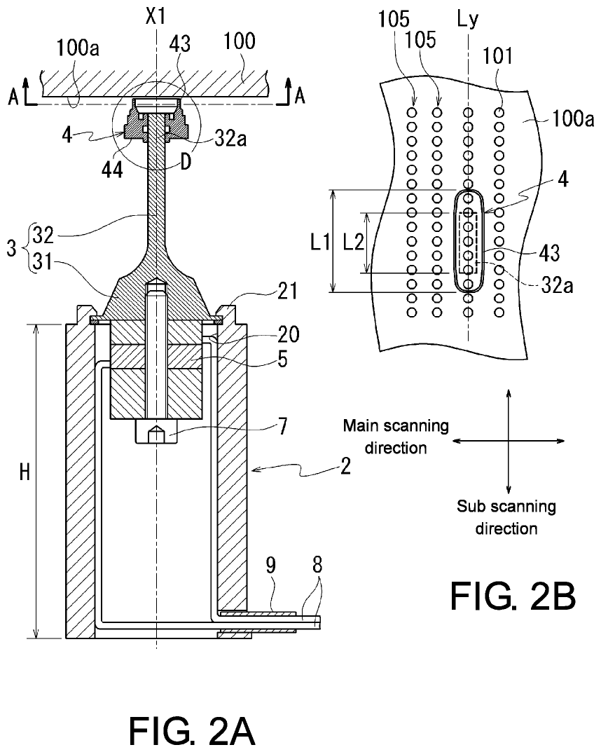

FIG. 2 are detailed drawings of the ejection nozzle cleaning device 1. FIG. 2(a) is a cross-sectional view of a gripping portion 2, a horn 3, a reservoir 4, and an inkjet head 100. FIG. 2(b) is a drawing that illustrates a position relationship between the reservoir 4 and nozzle arrays 105 on an ink ejection face 100a, during use of the ejection nozzle cleaning device 1. FIG. 2(b) is a cross-sectional view of FIG. 2(a) taken along A-A. In FIG. 2(b), a broken line shows the position of an edge 32a of the horn 3 on the inner side of a peripheral wall 43 of the reservoir 4.

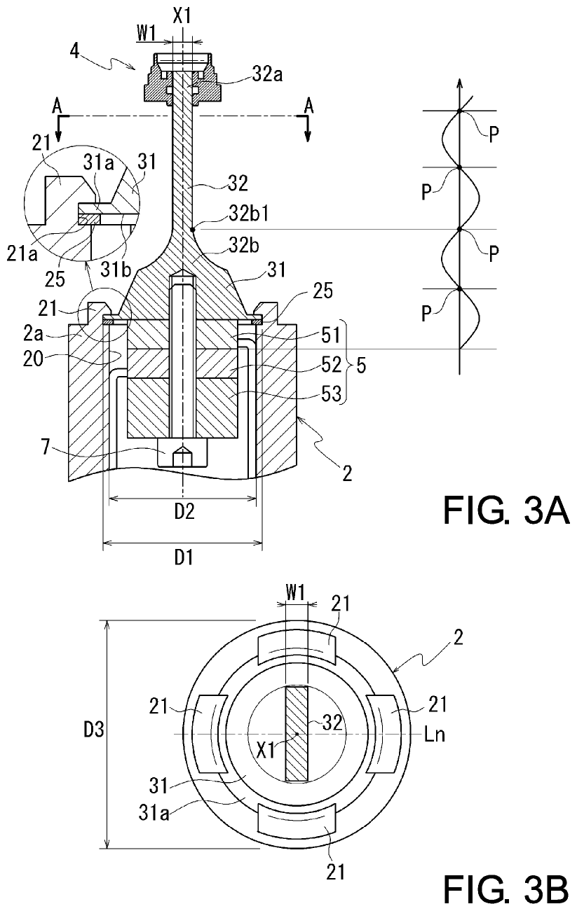

FIG. 3 are enlarged views of a main structural unit in the ejection nozzle cleaning device 1. FIG. 3(a) is a drawing that illustrates structures of the horn 3 being supported in the gripping portion 2 and of the horn 3 being coupled to an ultrasonic generator 5. FIG. 3(b) is a cross-sectional view of FIG. 3(a) taken along A-A.

FIG. 3(a) illustrates a relationship between shapes of the horn 3 and wavelength inflection points P of vibration generated by the ultrasonic generator 5.

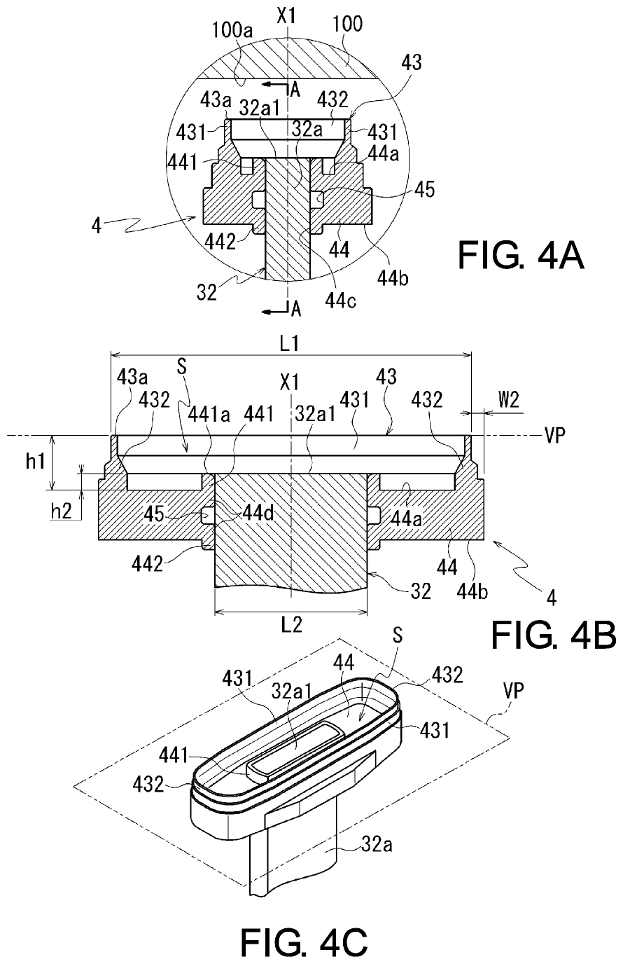

FIG. 4 are drawings of a reservoir 4 in the ejection nozzle cleaning device 1. FIG. 4(a) is a cross-sectional view of a coupled portion of the reservoir 4 and the horn 3. FIG. 4(b) is a cross-sectional view of FIG. 4(a) taken along A-A. FIG. 4(c) is a perspective view of the reservoir 4.

The ejection nozzle cleaning device 1 is used to clean ink ejection nozzles of inkjet printers. As illustrated in FIG. 1, the cleaning device 1 has a gripping portion 2 in tubular shape, a horn 3, a reservoir 4, a power supply unit 6, and an ultrasonic generator 5 disposed in the gripping portion 2 to vibrate the horn 3 (see FIG. 2(a)).

As illustrated in FIG. 2, the inkjet head 100 of an inkjet printer has an ink ejection face 100a on a side thereof that faces a printer medium (not illustrated in the drawings), and a plurality of ejection nozzles 101 arranged on the ink ejection face 100a (see FIG. 2(b)).

A plurality of nozzle arrays 105 are aligned on the ink ejection face 100a, and each nozzle array 105 has a plurality of ejection nozzles 101. The nozzle arrays 105 are spaced at predetermined intervals in a main scanning direction set for printing. A plurality of ejection nozzles 101 of each nozzle array 105 are spaced at predetermined intervals in a sub scanning direction set for printing.

When one portion of the plurality of ejection nozzles 101 are clogged with ink adhered to and solidified in the nozzle, the ejection nozzle cleaning device 1 is used to remove the solidified ink from the nozzle.

The gripping portion 2, which is held by a user who uses the device, is a tubular member having a length H in lengthwise direction and an outer diameter D3 (see FIG. 3(b)) that are small enough, so as to allow the gripping portion 2 to substantially stay in the user's hand.

The gripping portion 2 has, at one end 2a in lengthwise direction, engaging claws 21 that allow the horn 3 to be secured to the gripping portion 2.

As illustrated in FIG. 3(a), the engaging claws 21 protrude away from the gripping portion 2 along a center line X1 passing through the center of an opening 20 of the gripping portion 2. The engaging claws 21 each have a ring-shaped groove 21a in its inner periphery. The ring-shaped groove 21a is formed along the whole inner periphery around the center line X1.

An edge side of the engaging claw 21 with respect to the groove 21a may be accordingly radially displaceable relative to the center line X1.

There are four engaging claws 21 in total, which are spaced at predetermined intervals circumferentially around the center line X1.

The horn 3 has a flange 31a at a base 31 thereof. This flange 31a is fitted in the grooves 21a of the engaging claws 21. The horn 3 is securely attached to the gripping portion 2 with the engaging claws 21, and is protruding from the one end 2a of the gripping portion 2 and extending away from the gripping portion 2.

The base 31 of the horn 3 has an outer diameter substantially equal to the diameter of the opening 20 of the gripping portion 2. The flange 31a surrounding the whole outer periphery of engaged portions is formed on a bottom surface 31b of the base 31 closer to the gripping portion 2.

The flange 31a has a circular outer shape in a view from an axial direction of the center line X1. The flange 31a has an outer diameter D1 greater than an opening diameter D2 of the gripping portion 2.

When the horn 3 is attached to the gripping portion 2, the opening 20 of the gripping portion 2 closer to the one end 2a is closed with the base 31 of the horn 3 and the flange 31a (see FIG. 3(a)).

The flange 31a has a ring-shaped packing 25 on a surface thereof closer to the gripping portion 2.

In the horn 3, the bottom surface 31b of the base 31 closer to the gripping portion 2 is a flat surface orthogonal to the center line X1. The ultrasonic generator 5 is secured with bolts 7 to a central part of the bottom surface 31b.

The ultrasonic generator 5 is a Langevin transducer in which a pair of piezoelectric elements 51 and 52 are fitted between the base 31 of the horn 3 and a support member 53 with a bolt 7.

The piezoelectric elements 51 and 52 are disposed along the center line X1 and are expandable and contractible when voltage is applied thereto.

The piezoelectric elements 51 and 52 are coupled to the power supply unit 6 (see FIG. 1) through a power supply line 8 (see FIG. 2(a)). The piezoelectric elements 51 and 52 are vibrated in the direction of the center line X1 when a drive voltage is acted upon these elements through the power supply line 8.

The vibrations of the piezoelectric elements 51 and 52 are then transmitted to the horn 3 through the base 31 in contact with piezoelectric elements 51 and 52 so as to vibrate the horn 3 as a whole.

The base 31 has a truncated cone shape with an outer diameter progressively smaller as further away from the flange 31a. A vibration transmitter 32 is integrally formed on one side of the base 31 in a direction in which the horn 3 is extending (on the opposite side of the flange 31a).

The vibration transmitter 32 is a plate-like member having an edge 32a rectangular in cross section. The vibration transmitter 32 has a coupled portion 32b on one side thereof closer to the base 31. The coupled portion 32b is so shaped that its thickness W1 along a diametrical line Ln of the gripping portion 2 in a view from an axial direction of the center line X1 is greater toward the base 31.

The vibration transmitter 32 has the same thickness W1 on a side thereof closer to the edge 32a than a portion 32b1 on the boundary with the coupled portion 32b.

In this embodiment, the position of the boundary portion 32b1 in the direction of the center line X1 is coincident with a wavelength inflection point P of vibration generated by the ultrasonic generator 5. This may allow the generated vibration (ultrasonic vibration) to be amplified without being modulated, and then transmitted toward the edge 32a.

The ultrasonic generator 5 is secured to the horn 3 on the center line X1, and the vibration transmitter 32 of the horn 3 also lies on the center line X1.

When the ultrasonic generator 5 starts to generate ultrasonic vibration, the vibration transmitter 32 is vibrated around the center line X1. At the time, the plate-like edge 32a rectangular in cross section may be more vibrated around the center line X1 than the other parts of the vibration transmitter 32.

As illustrated in FIG. 4, a reservoir 4 is attached to the edge 32a on one side of the vibration transmitter 32 in the horn-extending direction. The reservoir 4 is a tubular member with a closed bottom and an opening on one side thereof. The reservoir 4 has an interior in which a cleaning liquid is containable.

The reservoir 4 includes a plate-like bottom wall 44 and a peripheral wall 43 that are integrally combined. The edge 32a of the horn 3 is penetrated through the bottom wall 44. The peripheral wall 43 surrounds the whole peripheral edge of the bottom wall 44. The reservoir 4 is made of an elastic material by which vibration of the horn 3 is absorbable. The shape of the reservoir 4 defined by the peripheral wall 43 and the bottom wall 44 is a non-limiting example. The reservoir 4 may have an optional shape, for example, a cone-shaped container, insofar as the cleaning liquid is containable.

The bottom wall 44 is directed orthogonal to the center line X1. The bottom wall 44 has, at a central part, a through cavity 44c penetrating through the bottom wall 44 in a thickness direction thereof (in the axial direction of the center line X1).

The edge 32a of the horn 3 is inserted in the through cavity 44c in the axial direction of the center line X1. The bottom wall 44 and the horn 3 are accordingly coupled to each other on the center line (see FIGS. 4(a) and 4(b)).

The peripheral wall 43 surrounding the whole peripheral edge of the bottom wall 44 is extending to a predetermined height h1 away from the gripping portion 2 along the extending direction of the horn 3. The edge 43a of the peripheral wall 43 lies on a virtual plane VP (see FIGS. 4(b) and 4(c)) orthogonal to the center line X1.

The edge 43a of the peripheral wall 43 is abutted against the ink ejection face 100a (see FIG. 2) of the inkjet head 100 during the use of the ejection nozzle cleaning device 1. During the use of the ejection nozzle cleaning device 1, the edge 43a of the peripheral wall 43 may be either abutted against the ink ejection face 100a or slightly spaced from the ink ejection face 100a.

The outer side surface of the peripheral wall 43 has a thickness W2 that decreases in phases toward the edge 43a in a direction orthogonal to the center line X1.

Then, a contact made by a surface of the edge 43a of the peripheral wall 43 abutted against the ink ejection face 100a is substantially a linear contact. A pressing force may be more concentrated on the surface of the edge 43a by having the thickness W2 decreased in phases than otherwise. This may prevent possible displacement of the reservoir 4 from an intended cleaning position during the cleaning operation. The peripheral wall 43 may possibly be unequal in height. Yet, it may be avoidable that the edge 43a deforms, leaving any gap between the edge 43a and the ink ejection face 100a.

In a view from an axial direction of the center line X1, the peripheral wall 43 has a tubular shape formed by a pair of long walls 431 parallel to each other across the center line X1, and a pair of short walls 432 parallel to each other and connecting ends of the long walls 431, as illustrated in FIG. 4. The opening of the peripheral wall 43 is rectangular in a view from an axial direction of the center line X1.

In the embodiment, the reservoir 4 has a tubular shape with a closed bottom in which one end of the tubular peripheral wall 43 is sealed with the bottom wall 44. A space surrounded by the peripheral wall 43 and the bottom wall 44 forms a storage space S in which the cleaning liquid, described later, is containable.

As illustrated in FIG. 2(b), the peripheral wall 43 and the edge 32a of the vibration transmitter 32 respectively have a predetermined length L1 and a predetermined length L2 in a direction along the nozzle array 105 (along a virtual line Ly illustrated in FIG. 2(b)), so that the ejection nozzles 101 of the nozzle array 105 are partly confined on the inner side of the peripheral wall 43.

In this embodiment, the cleaning liquid is an organic volatile solvent by which ink adhered to and solidified in the inkjet printer is dissoluble, and the reservoir 4 is made of an elastic material indissoluble by the cleaning liquid.

As illustrated in FIG. 4, a protruding wall 441 is formed in the storage space S containing the cleaning liquid along the whole peripheral edge of the through cavity 44c of the bottom wall 44. The protruding wall 441 is protruding from a bottom surface 44a of the bottom wall 44 along the center line X1 in the same direction that the peripheral wall 43 is protruding.

In this embodiment, the protruding wall 441 protrudes to a height h2 which is less than a half of the height h1 of the peripheral wall 43, so that an edge surface 441a of the protruding wall 441 is flush with an edge surface 32a1 of the edge 32a of the horn 3 penetrating through the through cavity 44c, and the edge 32a on one side of the horn 3 is located inside the peripheral wall 43.

A protruding wall 442 surrounding the whole peripheral edge of the through cavity 44c is formed on a surface 44b of the bottom wall 44 on the opposite side of the bottom surface 44a. The protruding wall 442 is protruding along the center line X1 in a direction opposite to the extending direction in which the peripheral wall 43 is extending.

In an inner peripheral surface of the through cavity 44c surrounding the center line X1, a ring-shaped groove 45 is formed along the whole circumferential length around the center line X1 so as to reduce a length of contact between the reservoir 4 and the horn 3 in the direction of the center line X1.

This may reduce the likelihood of vibration of the horn 3 being transmitted to the reservoir 4, thereby preventing attenuation of ultrasonic vibration, wavelength modulation, and large vibration of the reservoir 4.

In this embodiment, points of contact between the horn 3 and the reservoir 4 (protruding walls 441, 442) are spaced apart in the axial direction of the center line X1. Therefore, points at which the reservoir 4 is supported in the horn 3 are further spaced apart in the direction of the center line X1 than having the reservoir 4 supported by the bottom wall 44 alone. This may more certainly prevent any inclination of the reservoir 4 relative to the vibration transmitter 32 of the horn 3 (center line X1) than having the reservoir 4 supported by the bottom wall 44 alone.

The protruding walls (441, 442) are elastically deformable radially relative to the center line X1. In case any vibration-induced load is acted upon the protruding walls (441, 442), vibration may be absorbed and prevented from transmitting to the reservoir 4 as a result of radial displacements of the protruding walls (441, 442).

According to this structural advantage, vibration of the horn 3 may be prevented from transmitting to the reservoir 4 through the points of contact between the edge 32a and the protruding walls (441, 442).

The ultrasonic generator 5 is supplied with power from the power supply unit 6 through the power supply line 8 and is thereby driven to vibrate the horn 3. The power supply line 8 is coated with a coating material 9 rendered resistant to the cleaning liquid (see FIGS. 1 and 2).

In case the power supply line 8 is coated with any material vulnerable to the cleaning liquid, the cleaning liquid, if spilled over the reservoir 4, may decompose the coating, exposing a metal-made part of the power supply line 8. The coating material 9, on the other hand, may prevent such an unfavorable event by avoiding contact of the cleaning liquid with the power supply line 8.

The operation of the ejection nozzle cleaning device 1 is hereinafter described.

The reservoir 4 containing the cleaning liquid in the storage space S is pushed against the ink ejection face 100a of the inkjet head 100, so that the ink-clogged ejection nozzles 101 are confined on the inner side of the peripheral wall 43 of the reservoir 4.

The switch (not illustrated in the drawings) of the power supply unit 6 is pressed to drive the ultrasonic generator 5 and vibrate the horn 3.

In the horn 3 vibrated at the time, the edge 32a of the tapered vibration transmitter 32 may be most intensely vibrated.

The edge 43a of the peripheral wall 43 in the reservoir 4 has substantially the same height h1 throughout the whole circumference. In the tubular reservoir 4 with a closed bottom shaped by the peripheral wall 43 and the bottom wall 44, the cleaning liquid is contained in the storage space S, with the liquid center being drawn by surface tension slightly more outward than the edge 43a of the peripheral wall 43.

For cleaning of the ejection nozzles 101, the edge 43a of the peripheral wall 43 is abutted against the ink ejection face 100a or spaced slightly away from the ink ejection face 100a to make contact with the cleaning liquid. Then, ultrasonic vibration is acted upon the cleaning liquid to pulverize and remove ink adhered to and solidified in the ejection nozzles 101.

For removal of the solidified ink adhered to the nozzles, ultrasonic vibration is thus acted upon the cleaning liquid, with the edge 43a of the peripheral wall 43 being abutted against the ink ejection face 100a. This may prevent the ultrasonically vibrated cleaning liquid from leaking out of the reservoir 4.

Further, points of contact between the reservoir 4 and the ink ejection face 100a may be changeable, with the edge 43a of the peripheral wall 43 being abutted against the ink ejection face 100a. During the cleaning operation for the ink-adhered nozzles, therefore, the points of contact between the reservoir 4 and the ink ejection face 100a may be optionally changed without the risk of the cleaning liquid leaking out from between the reservoir 4 and the ink ejection face 100a to remove the solidified ink adhered.

As described so far, this embodiment provides,

(1) An ejection nozzle cleaning device 1 for an inkjet printer having ink ejection nozzles 101 that are arranged on an ink ejection face 100a of an inkjet head 100. The ejection nozzle cleaning device 1 includes: a gripping portion 2 to be held by a user; a horn 3 protruding from one end 2a of the gripping portion 2 and extending away from the gripping portion 2; a reservoir 4 disposed at an edge 32a of a vibration transmitter 32 on one side of the horn 3 in a direction in which the horn 3 is extending, the reservoir 4 being equipped to contain a cleaning liquid; and an ultrasonic generator 5 disposed at a base 31 of the horn 3 on another side thereof in the horn-extending direction so as to transmit ultrasonic wave to the horn 3. The reservoir 4 is a tubular member with a closed bottom and an opening in a part thereof that faces the ink ejection face 100a. The reservoir 4 has a storage space S (interior) in which the cleaning liquid is containable and has a through cavity 44c that allows the horn 3 to be at least partly inserted and located in the storage space S. A peripheral wall (wall) 43 that surrounds the opening of the reservoir 4 is formed to a height h1 that allows one side of the vibration transmitter 32 of the horn 3 to be located in the storage space S.

One side of the vibration transmitter 32 of the horn 3 is located in the storage space S of the reservoir 4. The cleaning liquid in the storage space S, therefore, may be directly vibrated by ultrasonic wave transmitted from the horn 3.

Thus, ultrasonic vibration may be acted upon the cleaning liquid in contact with a cleaning target region of the ink ejection face 100a, and may be directly acted upon the cleaning target region. Then, ink adhered to and solidified in the ejection nozzles 101 may be pulverized or dissolved and removed with a satisfactory cleaning effect.

The peripheral wall 43 surrounding the opening of the reservoir 4 is formed to the same height h1 throughout the whole circumference. During the cleaning operation, therefore, any gap may be avoidable between the ink ejection face 100a of the inkjet head 100 and the edge 43a of the peripheral wall 43 in contact with the ink ejection face 100a.

This may prevent the cleaning liquid in the reservoir 4 from leaking out of the reservoir 4 during the cleaning operation.

(2) The horn 3 is linearly extending from one end 2a of the gripping portion 2 toward one side in the extending direction of the horn 3, and in the vibration transmitter 32 of the horn 3, the reservoir 4 is located, with its opening being directed in the extending direction of the horn 3.

The horn 3 thus linearly extending may allow ultrasonic vibration generated by the ultrasonic generator 5 to arrive at the edge 32a and act upon the cleaning liquid without largely attenuating or modulating the ultrasonic vibration at an intermediate position in the extending direction of the horn 3. This may enhance a cleaning effect obtainable by ultrasonic vibration.

(3) The horn 3 includes the base 31, coupled portion 32b, and vibration transmitter 32 that are integrally combined, the base 31 is attachable to one end of the gripping portion 2 in the extending direction of the horn 3, the coupled portion 32b (diametrically reduced portion) is smaller in thickness in a direction orthogonal to the horn-extending direction as further away from the base 31 in the extending direction of the horn 3, the vibration transmitter 32 is a plate-like member having an edge 32a rectangular in cross section and extending from the coupled portion 32b in the horn-extending direction, and the coupled portion 32b is coincident with a waveform inflection point of ultrasonic wave generated by the ultrasonic generator 5 in the horn-extending direction.

Then, vibration generated by the ultrasonic generator 5 may be amplified instead of being attenuated and then transmitted to the edge 32a of the horn 3 serving as an ultrasonic radiator.

Thus, ultrasonic vibration at a desired frequency may be reliably conveyed through the horn 3 and acted upon the cleaning liquid in the reservoir 4.

Because of the edge 32a penetrating through the center of the bottom wall 44, the reservoir 4 may be unlikely to lean to either one side relative to the center line X1. The may prevent that the reservoir 4 is overly deformed in part by vibration of the horn 3 and becomes the origin of leakage of the cleaning liquid.

(4) The power supply unit 6 that supplies the ultrasonic generator 5 with power is provided separately from the gripping portion 2, the power supply unit 6 and the ultrasonic generator 5 are coupled to each other with the power supply line 8 to allow the gripping portion 2 to be located at an optional position away from the power supply unit 6, and the power supply line 8 is coated with the coating material 9 rendered resistant to the cleaning liquid.

An operator (user) may hold the gripping portion 2 and locate the reservoir 4 at an optional position on the ink ejection face 100a. The operator, therefore, may easily remove the adhered ink from the nozzles by locating the reservoir 4 at any ink-adhered positions on the ink ejection face 100a.

In case the power supply line 8 is coated with a coating material vulnerable to the cleaning liquid, the cleaning liquid, if leaked out of the reservoir 4, may decompose the coating, exposing a metal-made part of the power supply line 8. On the other hand, the power supply line 8 is coated with the coating material 9 rendered resistant to the cleaning liquid, which may prevent the cleaning liquid leaking out of the reservoir 4 from adhering to the power supply line 8. This may avoid such an unfavorable event that the coating-dissolved power supply line 8 is short-circuited.

Importantly, the coating material 9 may be used to cover a portion of the power supply line 8 drawn out of the gripping portion 2, i.e., a portion on the boundary with the gripping portion 2 and its vicinity. This may surely prevent any contact of the cleaning liquid with the power supply line 8 when, for example, the cleaning liquid flows out along the outer periphery of the gripping portion 2.

(5) The bottom wall 44 of the reservoir 4 has the through cavity 44c formed in the extending direction of the horn 3 which the edge 32a of the horn 3 penetrates through, and the through cavity 44c has the ring-shaped groove 45 formed at a central part on its inner periphery in the extending direction of the horn 3 so as to circumferentially surround the through cavity 44c.

This may reduce an area of contact between the reservoir 4 and the horn 3, reducing the likelihood of vibration of the horn 3 being transmitted to the reservoir 4.

The contact between the bottom wall 44 of the reservoir 4 and the edge 32a of the horn 3 is not a surface contact but is substantially a linear contact, resulting in a smaller area of contact. When the horn 3 is vibrated, therefore, any part of the reservoir 4 may be prevented from modulating or attenuating ultrasonic vibration.

(6) The reservoir 4 is made of an elastic material by which vibration of the horn 3 is absorbable.

When ultrasonic vibration is acted upon the cleaning liquid, the protruding walls (441, 442) in contact with the edge 32a of the horn 3 are elastically deformed. This may reduce the possibility of modulating or attenuating ultrasonic vibration transmitted from the edge 32a to the cleaning liquid. Further, vibration of the horn 3 may be less likely to transmit to the reservoir 4 and cause the reservoir 4 to vibrate.

Then, vibration of the horn 3 may be transmittable from the edge 32a of the horn 3 to the ink ejection face 100a through the cleaning liquid without being largely modulated or attenuated. Thus, ultrasonic vibration may be certainly acted upon a cleaning target to remove ink adhered to and solidified in the ejection nozzles 101.

While the horn 3 is vibrating, the reservoir 4 may be prevented from vibrating to a large extent. This may avoid possible damage to the ink ejection face 100a in contact with the edge 43a of the reservoir 4 resulting from frictional vibration against the edge 43a.

While the horn 3 is vibrating, large vibration of the reservoir 4 may be avoidable. This may prevent the cleaning liquid in the storage space S from leaking out under the impact of vibration.

The cleaning liquid containing the solidified ink removed from the ejection nozzles 101 (ink-contaminated cleaning liquid), therefore, may be less likely to leak out of the reservoir 4 and splash around. This may avoid smearing, for example, hands of an operator holding the gripping portion 2, inkjet printer's ink ejection face 100a, or ejection nozzle cleaning device 1, with the ink-contaminated cleaning liquid.

(7) The gripping portion 2, horn 3, and reservoir 4 lie on the center line X1 along the extending direction of the horn 3, the plate-like bottom wall 44 of the reservoir 4 is directed orthogonal to the extending direction of the horn 3 (in the direction of the center line X1), the peripheral wall 43 has its opening in the direction of the center line X1, and the gripping portion 2 is directed along the center line X1.

When an operator (user) holds the gripping portion 2, the gripping portion 2 settles in a circle defined with his/her hand's thumb and forefinger, allowing the operator to stably hold the reservoir 4 integral with the gripping portion 2.

The operator is then allowed to stably hold the reservoir 4 filled with the cleaning liquid up to the edge 43a of the peripheral wall 43 without unnecessarily swinging the gripping portion 2. Then, the cleaning liquid may be less likely to leak out of the reservoir 4.

The reservoir 4 is situated in the direction of the center line X1 of the tubular gripping portion 2 and may settle in the vicinity of the thumb and forefinger of an operator's hand holding the gripping portion 2.

With a space in the vicinity of the ink ejection face 100a of the inkjet head 100 that is large enough to accept a user's hand and the reservoir 4 exposed out of the hand, the user may put his/her hand holding the gripping portion 2 into the space to allow the cleaning liquid in the reservoir 4 to contact a cleaning target region.

During the cleaning operation, an operator may stably hold the gripping portion 2 and locate the reservoir 4 at a desired position. This may promise an improved cleaning efficiency.

(8) A plurality of engaging claws 21 radially displaceable relative to the center line X1 are formed at one end of the gripping portion 2 and are spaced at predetermined intervals circumferentially around the center line X1, and the horn 3 is detachably secured to one end of the gripping portion 2 with the engaging claws 21 engaged with the base 31 of the horn 3 (flange 31a).

A plurality of horns 3 may be prepared beforehand that respectively have vibration transmitters 32 that differ in shape and length. Then, solidified ink adhered to the ejection nozzles 101 may be removed by selecting a suitable one of the horns 3 in accordance with arrangement of the ejection nozzles 101 to be cleaned.

(9) The protruding wall 441 that circumferentially surrounds the through cavity 44c is formed on the bottom wall 44 in the same direction as the extending direction of the horn 3 (in the axial direction of the center line X1), and the edge surface 32a1 of the horn 3 is flush with the edge surface 441a of the protruding wall 441 in the reservoir 4.

The vibration transmitter 32 may not be perpendicular to the ink ejection face 100a when the reservoir 4 is abutted against the ink ejection face 100a. Yet, the peripheral wall 43 may continue to be perpendicularly pressed onto the ink ejection face 100a.

This may avoid that the cleaning liquid leaks out from between the reservoir 4 and the ink ejection face 100a.

The bottom wall 44 of the reservoir 4 is provided with the ring-shaped groove 45 and the protruding walls 441, 442, and points of contact between the bottom wall 44 of the reservoir 4 and the edge 32a of the horn 3 are spaced apart in the direction of the center line X1, so that vibration of the horn 3 is not directly transmitted to the reservoir 4.

The flange 31a of the horn 3 has a ring-shaped packing 25 on the surface closer to the gripping portion 2, so that vibration of the horn 3 is not directly transmitted to the gripping portion 2. Therefore, ultrasonic vibration of the horn 3 may be less likely to be attenuated or modulated.

The protruding walls 441, 442 of the reservoir 4 made of an elastic material are pressed against the outer periphery of the edge 32a of the horn 3 to avoid leakage of the cleaning liquid through the portion of the bottom wall 44 which the edge 32a of the horn 3 penetrates through.

The gripping portion 2 is extending in the direction of the opening of the peripheral wall 43 (storage space S) in the reservoir 4.

While an operator (user) is holding the gripping portion 2, the operator may be able to move the reservoir 4 in a more stable manner than when holding the gripping portion 2 extending along a direction orthogonal to the direction of the opening of the peripheral wall 43 (storage space S).

This may reduce the risk of the reservoir 4 being waggled and may accordingly prevent the cleaning liquid from spilling over the reservoir 4.

(10) The thickness W2 of the peripheral wall 43 in a direction orthogonal to the extending direction of the horn 3 is progressively smaller toward the edge 43a of the peripheral wall 43.

A contact made by the edge 43a of the peripheral wall 43 abutted against the ink ejection face 100a is substantially a linear contact. A pressing force may be more concentrated on the surface of the edge 43a by having the thickness W2 decreased than otherwise. This may prevent possible displacement of the reservoir 4 from an intended cleaning position during the cleaning operation. The peripheral wall 43 may possibly be unequal in height. Yet, it may be avoidable that the edge 43a deforms, leaving any gap between the edge 43a and the ink ejection face 100a.

### DESCRIPTION OF REFERENCE SIGNS

1 Ejection nozzle cleaning device

2 Gripping portion

2a One end

3 Horn

4 Reservoir

5 Ultrasonic generator

6 Power supply unit

8 Power supply line

9 Coating material

21 Engaging claw

31 Base

31a Flange

32 Vibration transmitter

32a1 Edge surface

32a Edge

43 Peripheral wall

43a Edge

44 Bottom wall

44c Through cavity

45 Ring-shaped groove

100 Inkjet head

100a Ink ejection face

101 Ejection nozzle

441 Protruding wall

441a Edge surface

442 Protruding wall

S Storage space

X1 Center line

1. An ejection nozzle cleaning device for an inkjet printer comprising a plurality of ink ejection nozzles that are arranged on an ink ejection face of an inkjet head, the ejection nozzle cleaning device comprising:
a gripping portion to be held by a user;
a horn, protruding from one end of the gripping portion and extending away from the gripping portion;
a reservoir, disposed on one side of the horn in an extending direction in which the horn is extending, the reservoir being equipped to contain a cleaning liquid; and
an ultrasonic generator, disposed on another side of the horn in the extending direction in which the horn is extending so as to transmit an ultrasonic wave to the horn,
wherein the reservoir being a tubular member with a closed bottom and an opening in a part thereof that faces the ink ejection face,
the reservoir having an interior in which the cleaning liquid is containable and comprising a through cavity that allows the horn to be at least partly inserted and located in the interior,
a wall that surrounds the opening of the reservoir being formed to a height that allows the one side of the horn to be located in the interior.

2. The ejection nozzle cleaning device for the inkjet printer as set forth in claim 1, wherein
the horn is linearly extending from the one end of the gripping portion toward the one side, and
the reservoir is provided with the opening being directed toward the one side of the horn.

3. The ejection nozzle cleaning device for the inkjet printer as set forth in claim 1, wherein the horn comprises:
a base, being attached to one end of the gripping portion;
a diametrically reduced portion, being smaller in thickness in a direction orthogonal to the extending direction as further away from the base in the extending direction; and
a vibration transmitter, being a plate-like member having an edge rectangular in cross section and extending from the diametrically reduced portion in the extending direction,
wherein the base, the diametrically reduced portion and the vibration transmitter are integrally combined,
the diametrically reduced portion in the extending direction is coincident with a waveform inflection point of the ultrasonic wave generated by the ultrasonic generator.

4. The ejection nozzle cleaning device for the inkjet printer as set forth in claim 1, further comprising:
a power supply unit that supplies the ultrasonic generator with power, the power supply unit being provided separately from the gripping portion,
the power supply unit and the ultrasonic generator are coupled to each other with a power supply line to allow the gripping portion to be located at an optional position away from the power supply unit, and
the power supply line is coated with a coating material rendered resistant to the cleaning liquid.

5. The ejection nozzle cleaning device for the inkjet printer as set forth in claim 1, wherein
the through cavity of the reservoir is formed in the extending direction in which the horn is extending and has a shape which an edge of the horn penetrates through, and
the through cavity has a ring-shaped groove formed at a central part on an inner periphery thereof in the extending direction, so as to circumferentially surround the through cavity.

6. The ejection nozzle cleaning device for the inkjet printer as set forth in claim 5, wherein
the reservoir is made of an elastic material.

7. The ejection nozzle cleaning device for the inkjet printer as set forth in claim 1, wherein
the gripping portion, the hone, and the reservoir lie on a reference line along the extending direction in which the horn is extending.

8. The ejection nozzle cleaning device for the inkjet printer as set forth in claim 7, wherein
a plurality of engaging claws radially displaceable relative to the reference line are formed at one end of the gripping portion, the plurality of engaging claws being spaced at predetermined intervals circumferentially around the reference line, and
the horn is detachably secured to one end of the gripping portion with the plurality of engaging claws engaged with the horn.

9. The ejection nozzle cleaning device for the inkjet printer as set forth in claim 8, wherein the reservoir comprises:
a protruding wall that surrounds a whole peripheral edge of the through cavity,
the protruding wall extending in the extending direction in which the horn is extending, and
an edge surface of the horn is flush with an edge surface of the protruding wall in the reservoir.

10. The ejection nozzle cleaning device for the inkjet printer as set forth in claim 9, wherein
a thickness of the wall in a direction orthogonal to the extending direction is progressively smaller toward an edge of the wall.

11. The ejection nozzle cleaning device for the inkjet printer as set forth in claim 2, wherein
the gripping portion, the horn, and the reservoir lie on a reference line along the extending direction in which the horn is extending.

12. The ejection nozzle cleaning device for the inkjet printer as set forth in claim 3, wherein
the gripping portion, the horn, and the reservoir lie on a reference line along the extending direction in which the horn is extending.

13. The ejection nozzle cleaning device for the inkjet printer as set forth in claim 4, wherein
the gripping portion, the horn, and the reservoir lie on a reference line along the extending direction in which the horn is extending.

14. The ejection nozzle cleaning device for the inkjet printer as set forth in claim 5, wherein
the gripping portion, the horn, and the reservoir lie on a reference line along the extending direction in which the horn is extending.

15. The ejection nozzle cleaning device for the inkjet printer as set forth in claim 6, wherein
the gripping portion, the horn, and the reservoir lie on a reference line along the extending direction in which the horn is extending.
